(19) United States
(12) Patent Application Publication
(10) Pub. No.: US 2010/0102012 A1
(43) Pub. Date: Apr. 29, 2010

(54) PRODUCT DISPLAY ARRANGEMENT AND METHOD OF MANUFACTURING PRODUCT DISPLAY ARRANGEMENT

(75) Inventors: Yoshio Iwasaki, Shiga (JP); Akira Yamamoto, Shiga (JP)

Correspondence Address: GLOBAL IP COUNSELORS, LLP, 1233 20TH STREET, NW, SUITE 700, WASHINGTON, DC, 20036-2680, US

(73) Assignee: ISHIDA CO., LTD., Kyoto (JP)

(21) Appl. No.: 12/529,733

(22) PCT Filed: Mar. 7, 2008
(86) PCT No.: PCT/JP2008/054186

§ 371 Date: Sep. 3, 2009

(30) Foreign Application Priority Data
Mar. 15, 2007 (JP) 2007-066319

(51) Int. Cl. A47F 7/00; B23P 11/00

(52) U.S. Cl. 211/49.1; 29/428

(57) ABSTRACT

A product display arrangement includes a strip member, a first product and a second product. The first product is affixed to the strip member. The second product is affixed to the strip member with the second product being aligned with respect to the first product. The second product is different in type from the first product with the first and second products being in a mutually complementary relationship.

This application claims priority to Japanese Patent Application No. 2007-066319, filed on Mar. 15, 2007. The entire disclosure of Japanese Patent Application No. 2007-066319 is hereby incorporated herein by reference.

### TECHNICAL FIELD

The present invention relates to a product display arrangement called a strip pack where plural products are affixed to a strip and displayed in a hanging state and to a method of manufacturing the product display arrangement, and the present invention belongs to the technical field of strip packs.

### BACKGROUND ART

Product displays called strip packs are known where a plurality of bagged products containing a snack food or the like are affixed to a strip for display. These strip packs are displayed in a hanging state, so they have the advantage that display space can be economized in a store whose sales floor space is small. Additionally, as a strip pack apparatus that manufactures such strip packs, there is the strip pack apparatus disclosed in Japanese Laid-Open Patent Application Publication No. 2004-115082, for example.

### DISCLOSURE OF THE INVENTION

In this connection, the product display arrangement manufactured by the apparatus described in the above mentioned publication is a product display arrangement where a plurality of products of the same type are affixed to a strip, and sometimes the product display arrangement has been unable to sufficiently accommodate the desire to display products of different types in small quantities each. Particularly in a store whose sales floor space is small, there has been the problem that it is difficult to stock such a product display arrangement from which products of the same type are hung.

Thus, it is an object of the present invention to provide a product display arrangement that can efficiently display plural types of products, particularly even in a store whose sales floor space is small, and a method of manufacturing the product display arrangement.

In order to solve this problem, a product display arrangement according to a first aspect of the invention includes a strip member, a first product and a second product. The first product is affixed to the strip member. The second product is affixed to the strip member with the second product being aligned with respect to the first product. The second product is different in type from the first product with the first and second products being in a mutually complementary relationship.

A product display arrangement according to a second aspect of the invention is the product display arrangement according to the first aspect of the invention, wherein the first product has a first back side that faces the strip member and a first front side on the opposite side of the first back side. The second product has a second back side that faces the strip member and a second front side on the opposite side of the second back side. The first product is affixed to the strip member so that the first front side is at least partially visible when seen from the front to an extent that the type of the first product is identifiable. The second product is affixed to the strip member so that the second front side is at least partially visible when seen from the front to an extent that the type of the second product is identifiable.

A product display arrangement manufacturing method according to a third aspect of the invention includes affixing a first product to a strip member, affixing a second product to the strip member after the affixing of the first product so that the second product is aligned with respect to the first product, the second product being different in type from the first product with the first and second products being in a mutually complementary relationship.

A product display arrangement manufacturing method according to a fourth aspect of the invention is the product display arrangement manufacturing method according to the third aspect of the invention, wherein the affixing of the first product includes affixing a first back side of the first product to the strip member such that a first front side of the first product is at least partially visible when seen from the front to an extent that the type of the first product is identifiable. The affixing of the second product includes affixing a second back side of the second product to the strip member so that a second front side of the second product is at least partially visible when seen from the front to an extent that the type of the second product is identifiable.

That is, the first aspect of the invention relates to a product display arrangement where plural products are affixed to a strip for display and is characterized in that each of bags in which the plural products are packaged is formed by a material that is capable of being affixed to the strip member, some of the products differ in type from the other products, and those products are products that are in a mutually complementary relationship.

Here, “products that are in a mutually complementary relationship” means products that are in a relationship where their utility value and commercial value might increase when they are purchased together because they are likely to be used together. Examples of the combination of products in a mutually complementary relationship include, but not limited to, the combination shown in FIG. 1 between bagged products X where a “snack food” such as potato chips is packaged in bags and bagged products H where “wet wipes” for wiping one's fingertips after eating that snack food are packaged in bags, or the combination shown in FIG. 3 between bagged products X where a “snack” such as peanuts is packaged in bags and bagged products H where “paper trays” for serving that snack are packaged in bags, or a combination of a bagged product where a “mask for protection against the cold” is packaged in a bag and a bagged product where “pocket tissues” for blowing one's nose are packaged in a bag, or the combination shown in FIG. 5 between a bagged product X1 where “cotton work gloves” are packaged in a bag, a bagged product X2 where a “work mask” is packaged in a bag and the like. Customers are induced into purchasing sets of such products as a result of these products being hung together on the strip member. Further, combinations of products are not limited to the preceding combinations.

Further, there are products whose packaging bags are capable of being affixed as they are to the strip member and products whose packaging bags are not capable of being affixed as they are to the strip member. When the bags are not capable of being affixed as they are to the strip member, the products therein are repackaged in advance in bags formed by a material that is capable of being affixed to the strip member. After the bag types of the products have been readied in this manner, the product display arrangement is formed using a strip pack apparatus such as the strip pack apparatus described in Japanese Laid-Open Patent Application Publication No. 2008-105701 and Japanese Laid-Open Patent Application Publication No. 2008-105705, for example, which have been filed by the applicant in the present case.

Additionally, the second aspect of the invention relates to a method of manufacturing a product display arrangement where plural products are affixed to a strip for display and is characterized in that plural products that differ in type and exist in a relationship where they are complementarily used with each other are sequentially affixed to the strip member in an aligned state.

According to the first aspect of the invention, by hanging plural products that differ in type on an elongate tape, plural types of products can be efficiently displayed, particularly even in a store whose sales floor space is small. Moreover, customers coming to purchase single products can be induced into purchasing other products that exist in a relationship where those other products are complementarily used with those single products. Further, customers intending to purchase those products together as a set can be saved the trouble of having to collect those products separately. Consequently, particularly in a store whose sales floor space is small, the types of products offered can be increased and sales can be increased by introducing such a new product display arrangement.

Additionally, according to the second aspect of the invention, a product display arrangement with which the aforementioned action and effects are obtained can be reliably manufactured by sequentially affixing, to the strip member in an aligned state, a plurality of products that differ in type and exist in a relationship where they are complementarily used with each other.

### BRIEF DESCRIPTION OF THE DRAWINGS

FIG. 1 is one example of a strip pack that serves as a product display arrangement pertaining to an embodiment of the present invention, with FIG. 1(a) being a front view and FIG. 1(b) being a side view;

FIG. 2 is a side view of a strip pack apparatus;

FIG. 3 is a front view of a different strip pack;

FIG. 4 is a front view of a different strip pack; and

FIG. 5 is a front view of a different strip pack.

### BEST MODES FOR CARRYING OUT THE INVENTION

Below, embodiments of the present invention will be described.

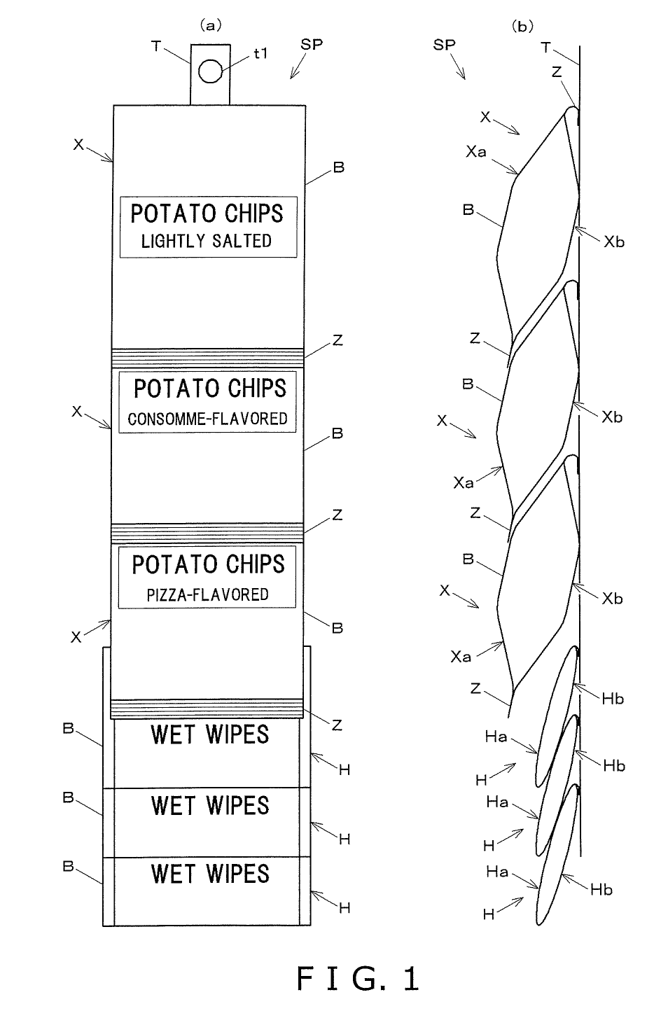

FIG. 1 is an example where a strip pack (product display arrangement) SP is formed by bagged products X where a “snack food (more specifically, potato chips)” is packaged in a bag and bagged products H where “wet wipes” for wiping one's fingertips after eating the snack food are packaged in a bag.

As shown in FIG. 1, three of the bagged products X and three of the bagged products H are affixed to a single elongate tape T (strip member) in a straight line along the direction in which the tape T extends (more specifically, the vertical direction). As shown in FIG. 1(b), the bagged products X and H are arranged in a state where parts of the bagged products X and H overlap each other. More specifically, of an arbitrary two of the bagged products that are mutually adjacent in the vertical direction, the upper portion of the lower product is tucked around the rear side of the lower portion of the upper product.

That is, as shown in FIG. 1(a), when seen from the front, the upper portions of all of the bagged products X and H excluding the uppermost bagged product X (lightly salted potato chips) are not visible because of the bagged products X and H that are one above. Conversely, when seen from the front, all of a front side Xa of the uppermost bagged product X is visible, and the middle portions and the lower portions excluding the upper portions of front sides Xa and Ha of the other bagged products X and H are visible. Consequently, information printed on the middle portions and the lower portions of the front sides Xa and Ha of the bagged products X and H mainly becomes information for a customer standing in front of the strip pack SP and choosing the bagged products X and H included in the strip pack SP to identify the types of the bagged products X and H. In the example of FIG. 1, product names (lightly salted potato chips, consommé-flavored potato chips, pizza-flavored potato chips, and wet wipes) are printed in areas that are visible when seen from the front, so a customer standing in front of the strip pack SP can easily identify the types of each of the bagged products X and H.

It will be noted that, in this specification, “front side of a product” is the side on which the type of the product easily comes across (e.g., the side where the product name is printed in large characters or letters) and “back side of a product” is the side on the opposite side of the front side. Additionally, each of the products is affixed to the tape T in a state where the back side of that product faces the tape T such that the front side of each product can be easily seen from the front side of the strip pack SP (the side from which the tape T is hidden by the products and cannot be seen). Further, “when seen from the front” means when seen from the front side of the strip pack SP.

Further, in another embodiment, it is preferable for a product whose type is difficult for a customer to identify unless the customer sees all of the front side of that product to be affixed to the tape T in a state where a distance where that product does not overlap a product that is one above is preserved with that product. That is, it is preferable for the distance between the two products that are mutually adjacent in the vertical direction to be adjusted such that the information that is printed on the front side of the lower product and makes it possible for the customer to identify the type of that product is not covered by the upper product when seen from the front.

Moreover, in another embodiment, when a plurality of products of the same type are continuously included in the strip pack, the uppermost product of those products may be arranged such that just the type of the uppermost product can be identifiable when seen from the front, and the other products may be covered by the same type of product to an extent that the type of the other products cannot be identifiable when seen from the front. This is because, when products of the same type overlap each other, as long as the type of the products that are covering can be identifiable, then the type of the products that are covered can also be similarly inferred by analogy. By superposing products of the same type in this manner, space can be rationally economized.

As long as bags B of the bagged products X and H are formed by a material that is capable of being heat-sealed with respect to the tape (strip) T, the strip pack SP can be formed without special efforts, but when this is not the case, the products therein are repackaged in bags formed by a material that is capable of being heat-sealed to the tape T. In this case, it is preferable for the bags into which the products are to be repackaged to be transparent if possible so that the contents can be seen.

After a plurality of the bagged products X and H that differ in type are prepared in this manner, they are arranged in an appropriate order, supplied to a later-described strip pack apparatus, and sequentially affixed to the tape T.

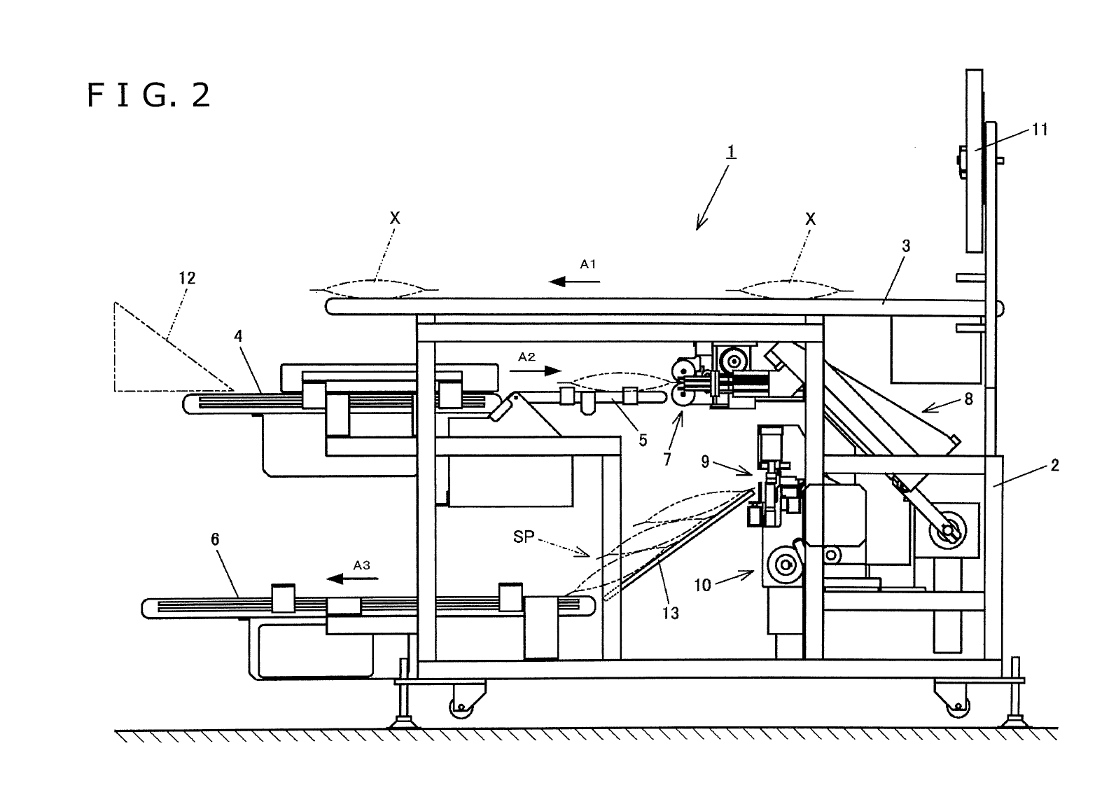

A strip pack apparatus 1 shown in FIG. 2 affixes the plural bagged products X (H) to the tape T to manufacture the strip pack SP. A body unit 2 is equipped with a supply conveyor 3 to which the bagged products X (H) are supplied from an upstream apparatus, an introduction conveyor 4 that introduces, to the inside of the apparatus 1, the bagged products X (H) that have been supplied by this supply conveyor 3, a drop conveyor 5 that configures a terminal end portion of this introduction conveyor 4, and a discharge conveyor 6 that discharges, to a downstream apparatus, the strip pack SP that has been manufactured by the apparatus 1. The body unit 2 also includes a brush unit 7 for smoothing out wrinkles in end portions of the bagged products X (H) that have been introduced to the inside of the apparatus 1, a gripping unit 8 for gripping the end portions of the bagged products X (H), an affixing unit 9 for affixing the bagged products X (H) at their end portions to the tape T, and a tape feeding unit 10 for feeding the tape T synchronously with the manufacture of the strip pack SP. Here, a roll 11 of the tape T is disposed in the upper portion of the body unit 2. It will be noted that the apparatus 1 has a configuration that is independent from upstream apparatus and downstream apparatus and has high versatility.

Here, the operation of manufacturing of the strip pack SP by the strip pack apparatus 1 is described. The bagged products X (H) that have been supplied to the apparatus 1 are conveyed by the supply conveyor 3 in the direction of arrow Al and are thereafter conveyed by the introduction conveyor 4 in a substantially horizontal direction in the direction of arrow A2, which is the opposite direction of the direction of arrow Al. A drop prevention member 12 for preventing the bagged products X (H) falling from the supply conveyor 3 from dropping outside the apparatus 1 is disposed on a starting end portion of the introduction conveyor 4.

Next, wrinkles in the end portions (that is, the seal portions) of the bagged products X (H) that have been conveyed by the drop conveyor 5 are smoothed out by the brush unit 7, and the bagged products X (H) are moved diagonally downward of the front side in the conveyance direction A2 in a state where the end portions are gripped by the gripping unit 8. At this time, the drop conveyor 5 slants such that its front side in the conveyance direction A2 becomes lower.

Then, the plural bagged products X (H) are affixed by the affixing unit 9 to the tape T that is fed by the tape feeding unit 10, whereby the strip pack SP is manufactured, and the strip pack SP that has been manufactured is delivered to the discharge conveyor 6 while being received by a slanted receiver 13 and is conveyed by this conveyor 6 in the direction of arrow A3.

As shown in FIG. 1, each of the bagged products X that are supplied to the apparatus 1 is a product where potato chips are enclosed in the bag B that is made of a plastic film, and each of the bagged products X has two seal portions Z and Z on its top and bottom. The bagged products X in this embodiment are ones where potato chips that are differ in flavor are enclosed. Further, the bagged products H that differ in type from the bagged products X are products where wet wipes are stored in the bags B that are made of a plastic film as with the bagged products X. Even if the bag size of the bagged products H differs from the bag size of the bagged products X, the gripping unit 8 is configured to change its gripping width depending on the bag size that has been detected by appropriate means, so these bagged products X and H are sequentially affixed to the tape T while they are conveyed at constant intervals.

Then, in the strip pack SP that is manufactured by the apparatus 1, the bagged products X and H are affixed in an aligned state to the elongate tape T at the seal portions Z on the top sides, and a punch hole t1 for fastening and displaying the strip pack SP in a hanging state is formed in one end of that tape T.

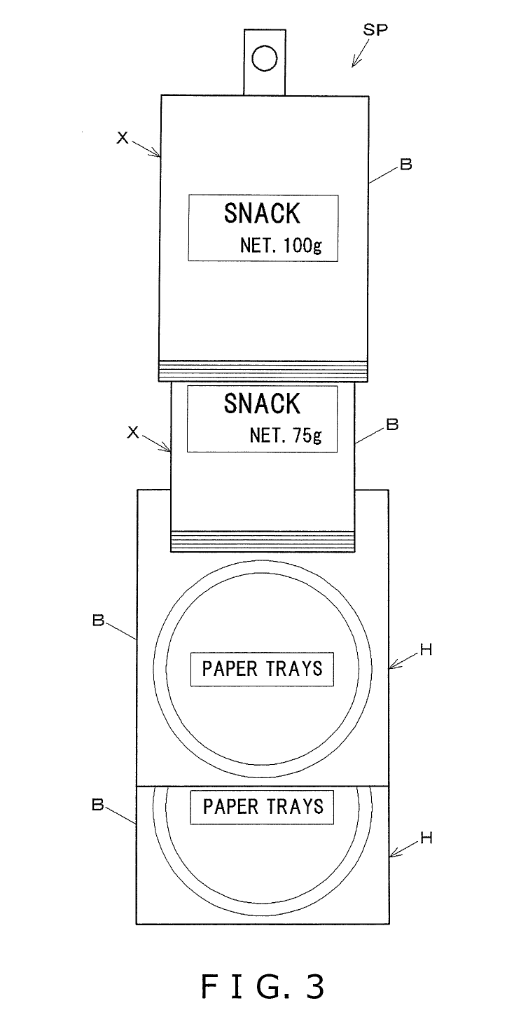

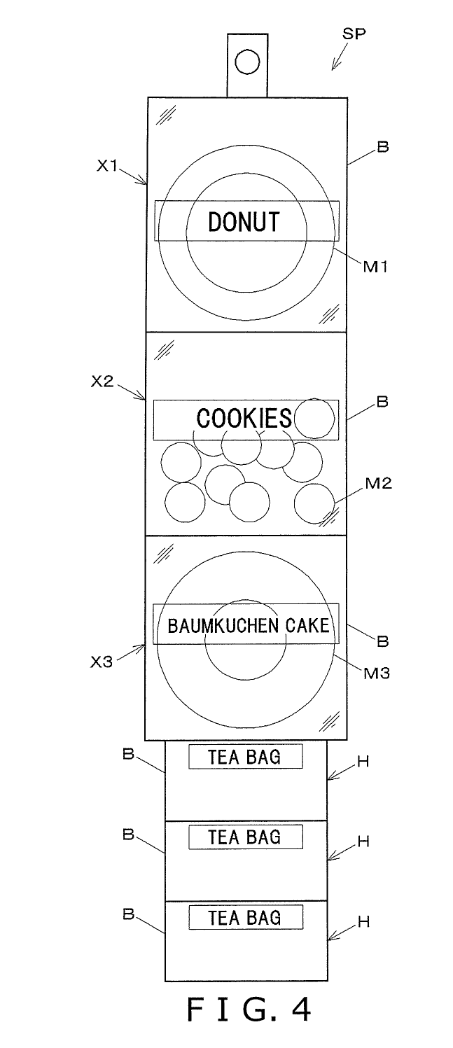

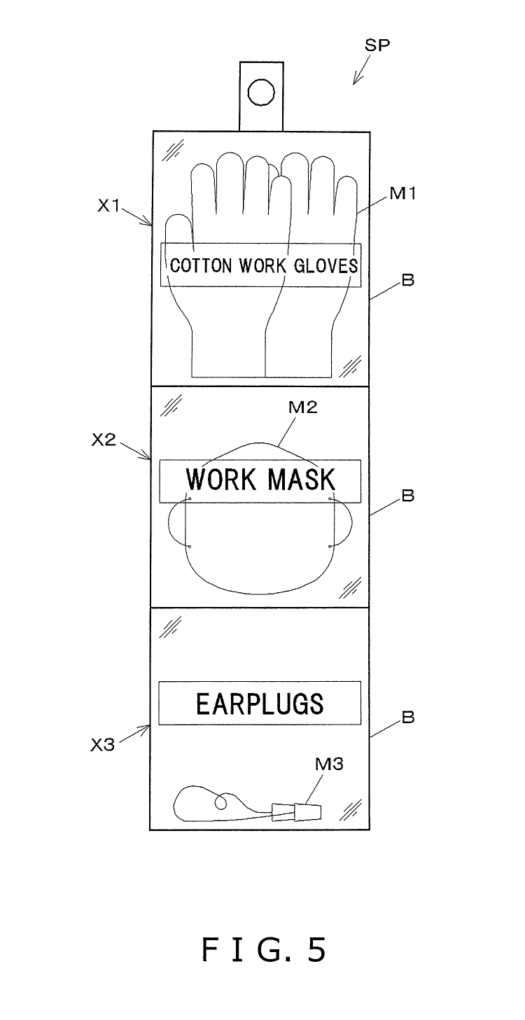

FIG. 3 shows a strip pack SP that is formed by sequentially supplying, to the apparatus 1, bagged products X where different amounts of a snack food are packaged in the bags B and bagged products H in each of which paper trays for serving the snack food are packaged in the bag B. FIG. 4 shows a strip pack SP that is formed by bagged products X1, X2 and X3 where a donut M1, cookies M2 and a Baumkuchen cake M3 are respectively packaged in the bags B and bagged products H in each of which a tea bag for one person is packaged in the bag B. FIG. 5 shows a strip pack SP that is formed by bagged products X1, X2 and X3 where cotton work gloves M1, a work mask M2 and earplugs M3 are respectively packaged in the bags B. It will be noted that supply of each of the bagged products X, X1 to X3 and H to the strip pack apparatus 1 can be performed easily by placing these products X, X1 to X3 and H at constant intervals on the introduction conveyor 4.

As described above, by hanging the plural products X, X1 to X3 and H that differ in type on the single elongate tape T, the plural types of products X, X1 to X3 and H can be efficiently displayed, particularly even in a store whose sales floor space is small. Moreover, customers coming to purchase single products can be induced into purchasing other products that exist in a relationship where those other products are complementarily used with those single products. Further, customers intending to purchase those products together as a set can be saved the trouble of having to collect those products from separate locations. Consequently, particularly in a store whose sales floor space is small, the types of products offered can be increased and sales can be increased by introducing such a new strip pack SP.

Additionally, a strip pack SP with which the aforementioned action and effects are obtained can be reliably manufactured by individually packaging, in the packaging bags B, contents that differ in type and exist in a relationship where they are complementarily used with each other, thereafter sequentially supplying these bagged products to the strip T, and then sequentially affixing each of the products X, X1 to X3 and H to the strip T in an aligned state.

It will be noted that the present invention is not limited to the preceding embodiments that have been specifically described and various changes to the described embodiments may be made within the spirits of the present invention.

For example, as the bagged products that are affixed to the tape T, in addition to the potato chip set, snack food set, western confectionary set and work gear set that have been described in the preceding embodiments, wide-ranging applied examples are conceivable, such as a camping equipment and dry cell battery set, a portable brush and shoe-wiping tissues set needed when grooming oneself, and a set of utensils used at parties and the like.

As described above, according to the illustrated embodiments, there are realized a product display arrangement that can efficiently display plural types of products, particularly even in a store whose sales floor space is small, and a method of manufacturing the product display. The product display arrangement and its manufacturing method according to the illustrated embodiments are widely suited to the technical field of strip packs.

1. A product display arrangement comprising:
a strip member;
a first product affixed to the strip member; and
a second product affixed to the strip member with the second product being aligned with respect to the first product, the second product being different in type from the first product, with the first and second products being in a mutually complementary relationship.

2. The product display arrangement according to claim 1, wherein
the first product has a first back side that faces the strip member and a first front side on the opposite side of the first back side,
the second product has a second back side that faces the strip member and a second front side on the opposite side of the second back side,
the first product is attached to the strip member so that the first front side is at least partially visible when seen from the front to an extent that the type of the first product is identifiable, and
the second product is attached to the strip member so that the second front side is at least partially visible when seen from the front to an extent that the type of the second product is identifiable.

3. A product display arrangement manufacturing method comprising:
affixing a first product to a strip member; and
affixing a second product to the strip member after the affixing of the first product so that the second product is aligned with respect to the first product, the second product being different in type from the first product with the first and second products being in a mutually complementary relationship.

4. The product display arrangement manufacturing method according to claim 3, wherein
the affixing of the first product includes affixing a first back side of the first product to the strip member such that a first front side of the first product is at least partially visible when seen from the front to an extent that the type of the first product is identifiable, and
the affixing of the second product includes affixing a second back side of the second product to the strip member such that a second front side of the second product is at least partially visible when seen from the front to an extent that the type of the second product is identifiable.
